(19) United States
(12) Patent Application Publication
(10) Pub. No.: US 2008/0141518 A1
(43) Pub. Date: Jun. 19, 2008

(54) AERIAL CABLE MARKER PLACEMENT TOOL

(75) Inventors: Bradley Robert Kokoski, Fort Mill, SC (US); Steven Jay Hahn, Lake Wylie, SC (US)

Correspondence Address: ADAMS INTELLECTUAL PROPERTY LAW, P.A., Suite 2350 Charlotte Plaza, 201 South College Street, CHARLOTTE, NC, 28244, US

(73) Assignee: JAMESON, L.L.C., Clover, SC (US)

(21) Appl. No.: 11/953,114

(22) Filed: Dec. 10, 2007

Related U.S. Application Data
(60) Provisional application No. 60/870,657, filed on Dec. 19, 2006.

(51) Int. Cl. B23P 11/00

(52) U.S. Cl. 29/428; 29/700

(57) ABSTRACT

An aerial cable marker placement tool that includes a bracket, hooks carried by the top portion of the bracket, and a cable marker support carried by the bracket and positioned in vertically spaced-apart relation below the hook for holding a cable marker having a cable retention channel in a first position spaced below the hook and as the cable marker is moved from the first position to a second position with the cable retention channel positioned on a cable.

This application claims priority based on U.S. Provisional Patent Application No. 60/870,657, filed Dec. 19, 2006.

### TECHNICAL FIELD AND BACKGROUND OF THE INVENTION

This invention relates to the field of aerial cable installations, and more particularly to devices and methods for accessing overhead cables from the ground using poles. The increase in aerial cable installations, as well as the ongoing creation, consolidation and buyout of telecommunication and cable television companies creates problems in keeping track of which overhead cables are owned and maintained by a particular utility company at any given time. To resolve problems of this type, many state and local utility regulatory councils have adopted standards for marking overhead cables in a manner that permits ownership or responsibility for the cable to be reliably determined. Some of the marking products are, for example, “clip-on” types of overhead tags or markers that are applied directly to the cable. These marking products are typically applied manually to the cables by service technicians working from aerial lift buckets mounted on the end of a boom carried by a utility truck. This practice, of course, is very expensive and time-consuming unless done at the same time with other service or installation work on the same or nearby cables.

For this reason, there exists a need for an inexpensive and easy-to-use product and method for applying identification markers to overhead cables.

### SUMMARY OF THE INVENTION

Therefore, it is an object of the invention to provide a product and method for applying identification markers to overhead cables.

It is another object of the invention to provide a product and method for applying identification markers to overhead cables that is inexpensive and easy-to-use.

It is another object of the invention to provide a product and method for applying identification markers to overhead cables that can be performed from the ground, and therefore avoids the necessity of an aerial lift bucket truck.

These and other objects and advantages of one preferred embodiment of the invention are disclosed below, and include an aerial cable marker placement tool, comprising a bracket, at least one hook carried by top portion of the bracket, a cable marker support carried by the bracket and positioned in vertically spaced-apart relation below the hook for holding a cable marker having a cable retention channel in a first position spaced below the hook and as the cable marker is moved from the first position to a second position with the cable retention channel positioned on a cable. The hook is adapted to engage a top surface of the cable marker channel and withdraw the cable marker from the cable marker support.

According to one embodiment of the invention, a fitting is provided for attaching the bracket to an extension pole.

According to another embodiment of the invention, the at least one hook comprises a pair of laterally spaced-apart hooks carried by the top portion of the bracket.

According to another embodiment of the invention, the pair of hooks are integrally formed with the bracket.

According to another embodiment of the invention, the cable marker support comprises a pair of laterally spaced-apart supports positioned on an end of the bracket remote from the pair of hooks and extending perpendicularly-outwardly from the bracket.

According to another embodiment of the invention, the fitting comprises a tube for receiving an end of the extension pole.

According to another embodiment of the invention, the cable marker supports are adapted to support a bottom edge of the cable marker.

According to another embodiment of the invention, the tube for receiving the end of the extension pole includes a spring for holding the cable marker against the bracket.

According to another embodiment of the invention, the bracket, the at least one hook and the cable marker support are integrally formed.

According to another embodiment of the invention, an aerial cable marker placement tool is provided, and comprises a bracket, including first and second laterally spaced-apart holding bars, each having a hook on a top end thereof and a cable marker support on a bottom end thereof. The hooks and cable marker supports are adapted to support a cable marker having a cable retention channel in a first position spaced below the hook, and as the cable marker is moved from the first position to a second position with an opening of the cable retention channel positioned adjacent a cable. The hooks are adapted to engage a top surface of the cable marker channel and withdraw the cable marker from the cable marker support during downward movement of the bracket while forcing the cable retention channel onto the cable.

According to a method embodiment of the invention, a method of attaching a cable marker to a cable is provided, and comprises the steps of providing a cable marker placement tool, including a bracket, at least one hook carried by top portion of the bracket, and a cable marker support carried by the bracket and positioned in vertically spaced-apart relation below the hook for holding a cable marker having a cable retention channel in a first position spaced below the hook and as the cable marker is moved from the first position to a second position with the cable retention channel positioned on a cable. The hook is adapted to engage a top surface of the cable marker channel and withdraw the cable marker from the cable marker support. The method further includes the steps of attaching a cable marker to the cable marker support in the first position, lifting the placement tool with the cable marker thereon to a cable and placing an opening of the cable retention channel of the cable marker adjacent the cable, and lowering the placement tool sufficiently to move the cable marker to a second position with the cable marker withdrawn from the cable marker support.

According to another embodiment of the invention, the method includes the step of forcing the cable marker retention channel onto the cable with the at least one hook.

According to another embodiment of the invention, the method includes the step of mounting the placement tool onto an extension pole.

According to another embodiment of the invention, the method includes the step of pinching the cable marker against the bracket to retain it in place on the cable support.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is a perspective view of a aerial cable marker placement tool according to one embodiment of the invention;

FIG. 2 is a perspective view of the placement tool shown in FIG. 1 in place on a pole;

FIGS. 3, 4, and 5 are sequential environmental views showing use of the placement tool to install a marker on a cable according to one embodiment of the invention.

### DESCRIPTION OF THE PREFERRED EMBODIMENT AND BEST MODE

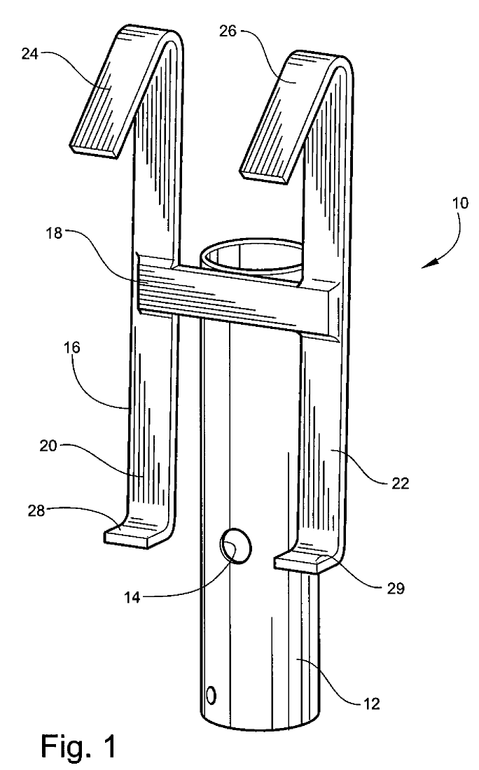

Referring now specifically to the drawings, a placement tool 10 according to one preferred embodiment of the invention is shown at broad reference numeral 10. Tool 10 includes a tube 12 having a hole 14 through one wall and an “H”-shaped bracket 16. The bracket 16 includes a cross-bar 18 and two laterally spaced-apart vertical marker holding bars 20, 22 welded to the cross-bar 18 in the manner shown in FIG. 1. The top ends of the holding bars 20, 22 are bent downwardly to form hooks 24, 26, and the bottom ends of the holding bars 20, 22 are bent outwardly to form marker supports 28, 29. The entire bracket 16 is preferably welded to the top end of the tube 12 in the manner shown in FIG. 1. The above-described elements are preferably constructed of steel, but aluminum or other suitable metal, or a heavy duty resin or plastic may be used. Attachment of the bracket 16 to the tube 12 may also be by bolts, pins, screws, or suitable adhesives.

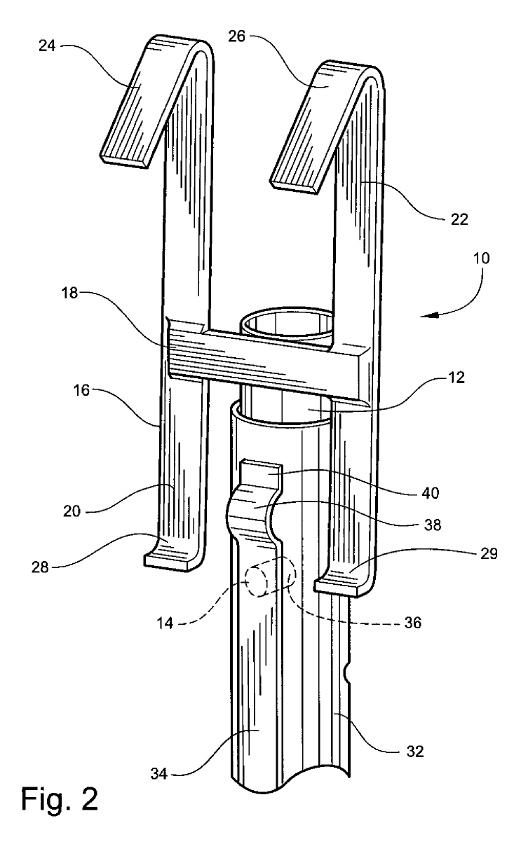

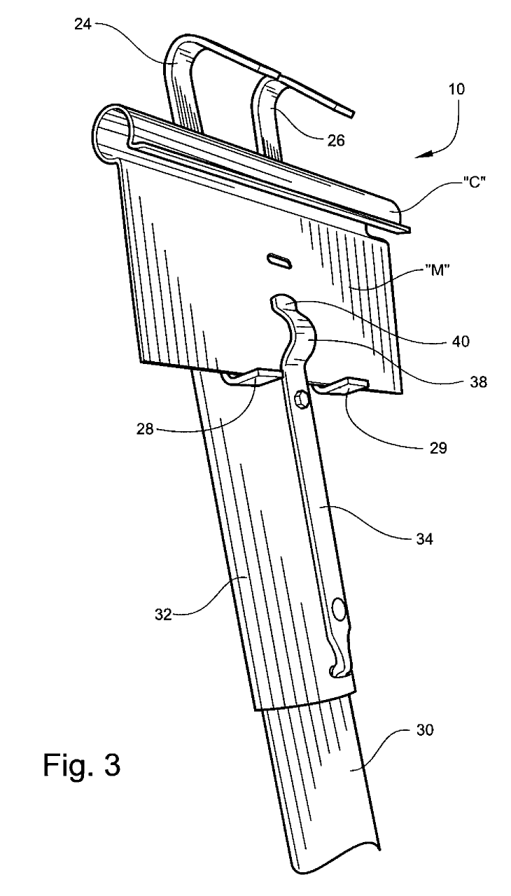

Referring now to FIGS. 2 and 3, extension poles 30, such as the type manufactured by MacLean Jameson LLC, of Clover. S.C., are typically fitted with a cylindrical aluminum ferrule 32 to which is mounted a leaf spring 43 having a button 36. This structure is used to attach other pole sections or other accessories such as pruning shears or saws. As is shown, the button 36 fits into the hole 14 in the tube 12 of the marker tool 10, locking it into place both axially and radially. The leaf spring 34 includes a finger grip 38 for use in extracting the button 36 from the hole 14 when removing and installing accessories. The distal end 40 of the leaf spring 34 bears forcefully against the ferrule 32 in order to maintain the button 36 in the hole 14.

As is also shown in FIGS. 2 and 3, the supports 28, 29 on the bottom end of the bracket 16 are at approximately the same level as the button 36 and below the level of the distal end 40 of the leaf spring 34. The supports 28, 29 support a cable marker “M”, and the distal end 40 of the leaf spring 34 pinches the bottom edge of the marker “M” against the ferrule 32 to thereby hold it securely in place on the supports 28, 29. The cable marker “M” includes an open channel “C” formed in the top edge that permits the marker “M” to be hung onto a cable.

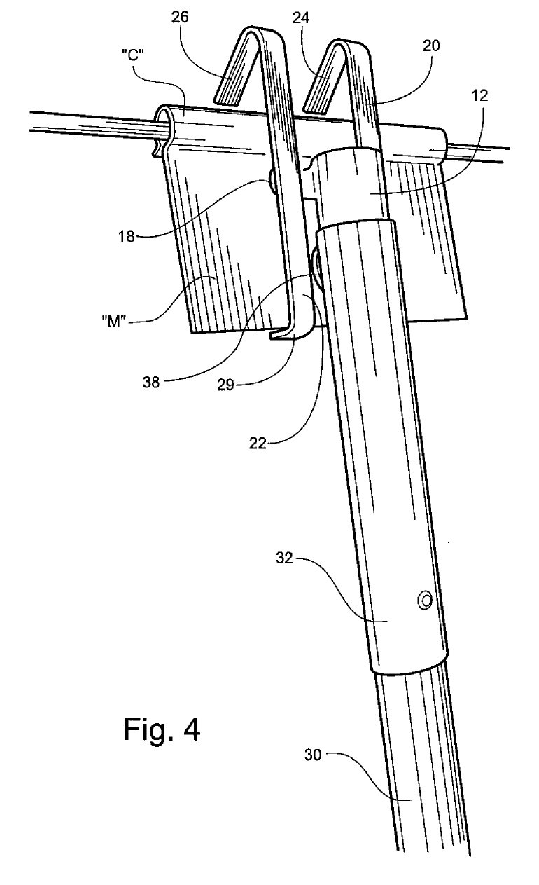

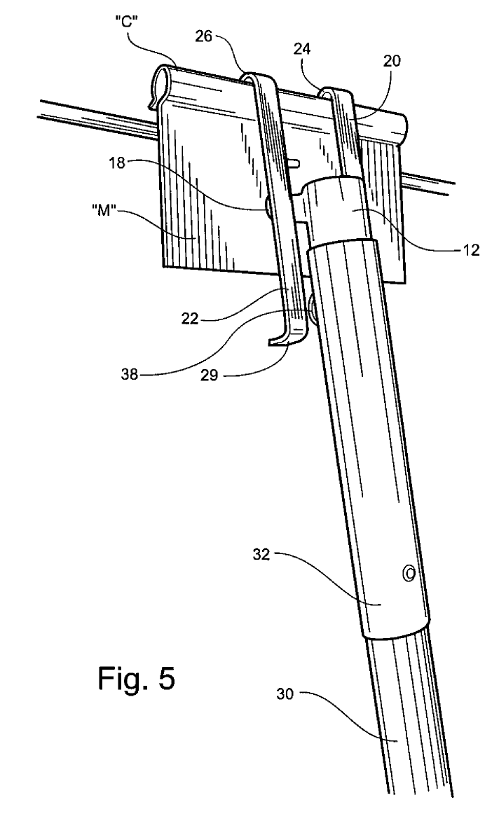

Referring now to FIGS. 3, 4 and 5, a utility worker installs the marker “M” on the bracket 16 as described above, and then extends the marker “M” upwardly to the cable to be marked using the extension pole 30 to which the tool 10 is attached (FIG. 3). The marker “M” is hooked over the cable by maneuvering the cable under and into the channel “C” on the top of the marker “M”. (FIG. 4). Note that the hooks 24, 26 on the top end of the bracket 16 are now in position in spaced-apart relation to and above the cable. The utility worker then pulls the pole 30 downwardly to release the marker “M” from underneath distal end 40 of the leaf spring 34. (FIG. 5). The marker “M” is now suspended from the cable and is released from the tool 10. The tool 10 can now be lifted to remove the hooks 24, 26 from the cable, lowered, loaded with another marker, and the procedure repeated. Depending on the size of the opening in the channel “C” in relation to the diameter of the cable, the hooks 24, 26 may also be used to force the cable into the channel “C” of the marker “M” as the hooks 24, 26 are pulled downwardly, as is apparent from the drawings, particularly FIG. 5.

While the particular embodiment described above takes advantage of a known type of pole having the ferrule and leaf spring attachment device, the invention is not limited to the particular means by which the tool is attached to a pole. The tool may be permanently attached to a pole by means of welding, pins, bolts, screws, screw threads, a bayonet-type mount, adhesives, clamps or any other suitable attachment means. Similarly, the use of tubular and flat bar stock for the tool is preferential, but other materials and fabrication processes are within the scope of the invention, including the use of plastic, resins, other metals or a combination of these, and the use of pins, bolts, adhesives, and molding processes to fabricate the tool.

An aerial cable marker replacement tool is described above. Various details of the invention may be changed without departing from its scope. Furthermore, the foregoing description of the preferred embodiment of the invention and the best mode for practicing the invention are provided for the purpose of illustration only and not for the purpose of limitation—the invention being defined by the claims.

We claim:

1. An aerial cable marker placement tool, comprising:
(a) a bracket;
(b) at least one hook carried by a top portion of the bracket; and
(c) a cable marker support carried by the bracket and positioned in vertically spaced-apart relation below the hook for holding a cable marker having a cable retention channel in a first position spaced below the hook and as the cable marker is moved from the first position to a second position with the cable retention channel positioned proximate a cable.

2. An aerial cable marker placement tool according to claim 1, and including a fitting for attaching the bracket to an extension pole.

3. An aerial cable marker placement tool according to claim 1, wherein the at least one hook comprises a pair of laterally spaced-apart hooks carried by the top portion of the bracket.

4. An aerial cable marker placement tool according to claim 3, wherein the pair of hooks are integrally formed with the bracket.

5. An aerial cable marker placement tool according to claim 3, wherein the cable marker support comprises a pair of laterally spaced-apart supports positioned on an end of the bracket remote from the pair of hooks and extending perpendicularly-outwardly from the bracket.

6. An aerial cable marker placement tool according to claim 2, wherein the fitting comprises a tube for receiving an end of the extension pole.

7. An aerial cable marker placement tool according to claim 5, wherein the cable marker supports are adapted to support a bottom edge of the cable marker.

8. An aerial cable marker placement tool according to claim 6, wherein the tube for receiving the end of the extension pole includes a spring for holding the cable marker against the bracket.

9. An aerial cable marker placement tool according to claim 1, wherein the hook is adapted to force the cable retention channel onto the cable.

10. An aerial cable marker placement tool, comprising:
(a) a bracket, including first and second laterally spaced-apart holding bars, each having a hook on a top end thereof and a cable marker support on a bottom end thereof;
(b) the hooks and cable marker supports adapted to support a cable marker having a cable retention channel in a first position spaced below the hook and as the cable marker is moved from the first position to a second position with an opening of the cable retention channel positioned adjacent a cable; and
(d) the hook adapted to engage a top surface of the cable marker channel and withdraw the cable marker from the cable marker support during downward movement of the bracket while forcing the cable retention channel onto the cable.

11. A method of attaching a cable marker to a cable, comprising the steps of:
(a) providing a cable marker placement tool, including:
(i) a bracket;
(ii) at least one hook carried by a top portion of the bracket: and
(iii) a cable marker support carried by the bracket and positioned in vertically spaced-apart relation below the hook for holding a cable marker having a cable retention channel in a first position spaced below the hook and as the cable marker is moved from the first position to a second position with the cable retention channel positioned on a cable;
(b) attaching a cable marker to the cable marker support in the first position;
(c) lifting the placement tool with the cable marker thereon to a cable and placing an opening of the cable retention channel of the cable marker adjacent the cable; and
(d) lowering the placement tool sufficiently to move the cable marker to a second position with the cable marker withdrawn from the cable marker support.

12. A method according to claim 11, and including the step of forcing the cable marker retention channel onto the cable with the at least one hook.

13. A method according to claim 11, and including the step of mounting the placement tool onto an extension pole.

14. A method according to claim 11, and including the step of pinching the cable marker against the bracket to retain it in place on the cable support.
